(19) United States
(12) Patent Application Publication
(10) Pub. No.: US 2009/0325842 A1
(43) Pub. Date: Dec. 31, 2009

(54) Foaming Hard Surface Cleaning Composition

(75) Inventor: Mattia DeDominicis, Gauteng (ZA)

Correspondence Address: Parfomak, Andrew N., 875 THIRD AVE, 8TH FLOOR, NEW YORK, NY, 10022, US

(73) Assignee: Reckitt Benckiser Inc., Parsippany, NJ (US)

(21) Appl. No.: 12/304,532

(22) PCT Filed: May 9, 2007
(86) PCT No.: PCT/GB2007/001694

§ 371 Date: Jun. 15, 2009

Related U.S. Application Data
(60) Provisional application No. 60/804,948, filed on Jun. 16, 2006.

(51) Int. Cl. C11D 3/20

(52) U.S. Cl. 510/238

(57) ABSTRACT

Alkaline ready to use cleaning composition which is particularly directed for the effective removal of soap scum stains on hard surfaces and which is essentially free of a chelating agent based on a nitrogen containing organic acid compound.

The present invention relates to hard surface cleaning compositions. More particularly the present invention relates to foaming, alkaline hard surface cleaning compositions preferably provided in a pressurized container, e.g., aerosol container, which is particularly useful in the cleaning of hard surfaces. The compositions are particularly useful in the cleaning of a variety of soils, particularly on greasy soils as well as soap scum.

As is known to the art, hard surfaces associated with lavatories (including lavatory appliances especially washing sinks, shower stalls and bathtubs) are typically prone to accumulate soap scum stains. Such surfaces are usually made of materials such as tiles (glazed and unglazed), marble, ceramics and enameled porcelain surfaces. The latter include European porcelain surfaces which generally are more prone to damage or discoloration due to the use of particularly aggressive cleaning compositions, especially those with low pH values. The use of acidic compositions are typically not compatible with such “European porcelain” or “European enamel” hard surfaces. Thus, acid cleaning compositions are desirably to be avoided for use in cleaning such surfaces. The use of alkaline cleaning compositions are therefore preferred, however most alkaline cleaning compositions are not sufficiently satisfactory to effectively clean soap scum stains from surfaces. This shortcoming has been met in the art by the require the inclusion of an effective amount of a chelating agent which is typically based on one or more organic acid compounds, especially nitrogen containing organic compounds which include a plurality of carboxylic acid groups. Such chelating agents include gluconic acid, tartartic acid, citric acid, oxalic acid, lactic acid, ethylenediamine mono-, di- or tri-acetic acid, ethylenediaminetetraacetic acid, N-hydroxyethylethylenediamine triacetic acid, nitrilotriacetic acid, diethylene triamine pentaacetic acid, and their water soluble salts of these compounds, especially the alkali metal salts and particularly the sodium salts.

While such a chelating agents, particularly nitrogen containing chelating agents are generally recognized in the art as being effective in the removal of soap scum stains, there are growing environmental concerns attendant upon their use. The use of such chelating agents based on organic acid compounds, especially nitrogen containing organic compounds which include a plurality of carboxylic acid groups especially ethylenediamine mono-, di- or tri-acetic acid, ethylenediaminetetraacetic acid are desirably to be avoided.

Furthermore, acidic hard surface cleaning compositions which may be effective on soap scum stains do not always show good cleaning efficacy on greasy stains which are not soap scum stains but which may be found on lavatory surfaces, and for that matter, may also be found in other loci, e.g, such kitchen surfaces, flooring surfaces, tile surfaces, vehicle surfaces, and the like. Indeed, hard surface cleaning compositions which are expected to be effective in the cleaning of soap scum stains from hard surfaces are not expected to be effective upon greasy soils and hardened or dried greasy soils, as well as the obverse.

Thus the inventive compositions provide compositions which are effective for the removal of such stains on such surfaces.

Accordingly in a first aspect of the invention there is provided a foaming, alkaline hard surface cleaning composition which is effective in the cleaning of various stains, particularly one or more of soap scum stains and greasy soil stains from hard surfaces. The composition may be provided in a non-pressurized product format, but is preferably provided in a pressurized aerosol canister or package.

According to a second aspect of the invention there is provided a foaming, alkaline hard surface cleaning compositions which is effective in the cleaning of various stains, particularly one or more of soap scum stains an greasy soil stains from hard surfaces which exhibits a quick breaking foam or even a bubbling action when applied to a hard surface in need of a cleaning treatment.

In a third aspect of the invention there is provided a foaming, alkaline hard surface cleaning composition according to the first or second aspects of the invention which is essentially free of conventional chelating agents.

In a fourth aspect of the invention there is provided a foaming, alkaline hard surface cleaning composition according to the first or second aspects of the invention which is essentially free of conventional nitrogen-containing chelating agents.

According to a fifth aspect of the invention there is provided a process for the cleaning of hard surfaces, particularly one or more of soap scum stains and greasy soil stains from hard surfaces from said surfaces which process contemplates the application of an effective amount of a foaming, alkaline hard surface cleaning composition according to any of the prior recited aspects of the invention.

According to a sixth aspect of the invention there is provided a process for the manufacture of a foaming, alkaline hard surface cleaning composition according to one or more of the first through fourth aspects of the invention recited above.

Broadly speaking, the compositions of the present invention is to a hard surface comprise a solvent system which includes one or more organic solvents; a surfactant selected from the group consisting of anionic surfactant, non-ionic surfactant, and mixtures thereof; a propellant; and water. The composition may also contain a hydrotrope. The composition optionally contains one or more cationic surfactants, one or more corrosion inhibitors, pH buffering agents, perfumes, perfume carriers, pH adjusting agents, pH buffers, antioxidants, antimicrobials, germicidals, fungicidals, acaricides, allergen neutralizer and preservatives, wherein the foam breaks within ten minutes of application to a hard surface. Preferred compositions of the invention are effective in cleaning one or more of soap scum stains and greasy soil stains from hard surfaces from said surfaces. In certain preferred embodiments the compositions are free from conventional chelating agents, including nitrogen-containing chelating agents.

The compositions of the invention necessarily include a solvent system which comprises one or more organic solvents. The organic solvents may be selected from one or more of: glycol ethers, m-Pyrol, low molecular weight monohydric alcohols, and mixtures thereof.

Exemplary useful glycol ethers are those having the general structure Rₐ—O—R_{b}—OH, wherein Rₐ is an alkyl of 1 to 20 carbon atoms, or an aryl of at least 6 carbon atoms, and R_{b} is an alkylene of 1 to 8 carbons or is an ether or polyether containing from 2 to 20 carbon atoms. Exemplary glycol ethers include, ethylene glycol monomethyl ether, ethylene glycol monobutyl ether, ethylene glycol ethyl ether, ethylene glycol hexyl ether, diethylene glycol monomethyl ether, diethylene glycol monobutyl ether, propylene glycol phenyl ether, propylene glycol monomethyl ether, diethylene glycol phenyl ether, dipropylene glycol methyl ether, propylene glycol monopropyl ether, dipropylene glycol monopropyl ether, propylene glycol monobutyl ether, dipropylene glycol monobutyl ether, propylene glycol phenol ether, propylene glycol isobutyl ether, tripropylene glycol methyl ether, dipropylene glycol monobutyl ether and ethylene glycol monohexyl ether, as well as mixtures thereof.

Examples of low molecular weight monohydric alcohols include C₁-C₆ monohydric alcohols such as methanol, ethanol, n-propanol, isopropanol, as well as all of the various positional isomers of butanol, with isopropanol being preferred.

Preferably, the organic solvent system is selected from the group consisting of: propylene glycol monopropyl ether or alternately, is a mixture of dipropylene glycol methyl ether and dipropylene glycol monobutyl ether.

In certain particularly preferred embodiments the organic solvent system comprises propylene glycol n-propyl ether to the exclusion of other glycol ether solvents and more preferably to the exclusion of other organic solvents. In certain other particularly preferred embodiments the organic solvent system comprises dipropylene glycol n-butyl ether with dipropylene glycol methyl ether, preferably wherein the dipropylene glycol n-butyl ether is present in an amount in excess of the dipropylene glycol methyl ether present in the composition, yet more preferably wherein, on a % w/w basis, the dipropylene glycol n-butyl ether and dipropylene glycol methyl ether are both present in respective weight ratios of 1:1.2 or more, more advantageously 1:1.3 or more, still more advantageously 1:1.5 or more, yet more advantageously 1:2 or more, and most advantageously 1:2.5 or more; yet more preferably according to this embodiment the organic solvent system comprises dipropylene glycol n-butyl ether with dipropylene glycol methyl ether to the exclusion of other organic solvents. In still further particularly preferred embodiments the organic solvent system comprises ethylene glycol n-butyl ether with a C₁-C₆ monohydric alcohol, most preferably a isopropanol, preferably wherein the ethylene glycol n-butyl ether is present on a % w/w basis, in an amount in excess of the C₁-C₆ monohydric alcohol present in the composition, yet more preferably wherein the ethylene glycol n-butyl ether and C₁-C₆ monohydric alcohol, are both present in respective weight ratios of 1.5:1 or more, more advantageously 2:1 or more, and most advantageously 2.5:1 or more; yet more preferably according to this embodiment the organic solvent system comprises ethylene glycol n-butyl ether with a C₁-C₆ monohydric alcohol, most preferably a isopropanol, to the exclusion of other organic solvents.

The one or more organic solvents present in the composition comprise at least 15% wt., preferably between 15%-40% wt. of the inventive compositions, yet more preferably between 17%-40% wt. of the compositions of which they form a part.

The compositions of the invention necessarily include at least one surfactant selected from the group consisting of anionic surfactants and non-ionic surfactants.

With regard to non-ionic surfactants, it is contemplated that virtually all known art nonionic surfactants may be used in the present inventive compositions. Illustrative examples of suitable nonionic surfactants include, inter alia, condensation products of alkylene oxide groups with an organic hydrophobic compound, such as an aliphatic compound or with an alkyl aromatic compound. The nonionic synthetic organic detergents generally are the condensation products of an organic aliphatic or alkyl aromatic hydrophobic compound and hydrophilic ethylene oxide groups. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic detergent. Further, the length of the polyethenoxy hydrophobic and hydrophilic elements may be varied to adjust these properties. Illustrative examples of such a nonionic surfactants include the condensation product of one mole of an alkyl phenol having an alkyl group containing from 6 to 12 carbon atoms with from about 5 to 25 moles of an alkylene oxide. Another example of such a nonionic surfactant is the condensation product of one mole of an aliphatic alcohol which may be a primary, secondary or tertiary alcohol having from 6 to 18 carbon atoms with from I to about 10 moles of alkylene oxide. Preferred alkylene oxides are ethylene oxides or propylene oxides which may be present singly, or may be both present.

Still further illustrative examples of nonionic surfactants include primary and secondary linear and branched alcohol ethoxylates, such as those based on C₆-C₁₈ alcohols which further include an average of from 2 to 80 moles of ethoxylation per mol of alcohol. Examples include the Genapol® series of linear alcohol ethoxylates from Clariant Corp., Charlotte, N.C. The 26-L series is based on the formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1, 26-L-1.6, 26-L-2, 26-L-3, 26-L-5, 26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3, 24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

Further examples of useful nonionic surfactants include secondary C₁₂-C₁₅ alcohol ethoxylates, including those which have from about 3 to about 10 moles of ethoxylation. Such are available in the Tergitol® series of nonionic surfactants (Dow Chemical, Midland, Mich.), particularly those in the Tergitol® “15-S-” series. Further exemplary nonionic surfactants include linear primary C₁₁-C₁₅ alcohol ethoxylates, including those which have from about 3 to about 10 moles of ethoxylation. Such are available in the Tomadol® series of nonionic surfactants under the following tradenames: Tomadol 1-3 (linear C₁₁ alcohol with 3 moles (average) of ethylene oxide); Tomadol 1-5 (linear C₁₁ alcohol with 5 moles (average) of ethylene oxide); Tomadol 1-7 (linear C₁₁ alcohol with 7 moles (average) of ethylene oxide); Tomadol 1-9 (linear C₁₁ alcohol with 9 moles (average) of ethylene oxide); Tomadol 23-1 (linear C₁₂₋₁₃ alcohol with 1 mole (average) of ethylene oxide); Tomadol 23-3 (linear C₁₂₋₁₃ alcohol with 3 moles (average) of ethylene oxide); Tomadol 23-5 (linear C₁₂₋₁₃ alcohol with 5 moles (average) of ethylene oxide); Tomadol 23-6.5 (linear C₁₂₋₁₃ alcohol with 6.6 moles (average) of ethylene oxide); Tomadol 25-12 (linear C₁₂₋₁₅ alcohol with 11.9 moles (average) of ethylene oxide); Tomadol 25-3 (linear C₁₂₋₁₅ alcohol with 2.8 moles (average) of ethylene oxide); Tomadol 25-7 (linear C₁₂₋₁₅ alcohol with 7.3 moles (average) of ethylene oxide); Tomadol 25-9 (linear C₁₂₋₁₅ alcohol with 8.9 moles (average) of ethylene oxide); Tomadol 45-13 (linear C₁₄₋₁₅ alcohol with 12.9 moles (average) of ethylene oxide); Tomadol 45-2.25 (linear C₁₄₋₁₅ alcohol with 2.23 moles (average) of ethylene oxide); Tomadol 45-7 (linear C₁₄₋₁₅ alcohol with 7 moles (average) of ethylene oxide); Tomadol 91-2.5 (linear C₉₋₁₁ alcohol with 2.7 moles (average) of ethylene oxide); Tomadol 91-6 (linear C₉₋₁₁, alcohol with 6 moles (average) of ethylene oxide); Tomadol 91-8 (linear C₉₋₁₁ alcohol with 8.3 moles (average) of ethylene oxide) (Tomah Products, Inc., Milton, Wis.).

Further examples of useful nonionic surfactants include C₆-C₁₅ straight chain alcohols ethoxylated with about 1 to 13 moles of ethylene oxide, particularly those which include about 3 to about 6 moles of ethylene oxide. Examples of such nonionic surfactants include Alfonic® 810-4.5, which is described as having an average molecular weight of 356, an ethylene oxide content of about 4.85 moles and an HLB of about 12; Alfonic® 810-2, which is described as having an average molecular weight of 242, an ethylene oxide content of about 2.1 moles and an HLB of about 12; and Alfonic® 610-3.5, which is described as having an average molecular weight of 276, an ethylene oxide content of about 3.1 moles, and an HLB of 10.

Further examples of suitable nonionic surfactants for use as the (b) at least one nonionic surfactant include include alkyl glucosides, alkyl polyglucosides and mixtures thereof. Alkyl glucosides and alkyl polyglucosides can be broadly defined as condensation articles of long chain alcohols, e.g., C₈-C₃₀ alcohols, with sugars or starches or sugar or starch polymers i.e., glycosides or polyglycosides. These compounds can be represented by the formula (S)ₙ—O—R wherein S is a sugar moiety such as glucose, fructose, mannose, and galactose; n is an integer of from about 1 to about 1000, and R is a C₈₋₃₀ alkyl group. Examples of long chain alcohols from which the alkyl group can be derived include decyl alcohol, cetyl alcohol, stearyl alcohol, lauryl alcohol, myristyl alcohol, oleyl alcohol and the like. Commercially available examples of these surfactants include decyl polyglucoside (available as APG 325 CS from Henkel) and lauryl polyglucoside (available as APG 600 CS and 625 CS from Henkel).

A further class of nonionic surfactants which may find use in the present inventive compositions include ethoxylated octyl and nonyl phenols include those having one of the following general structural formulas:

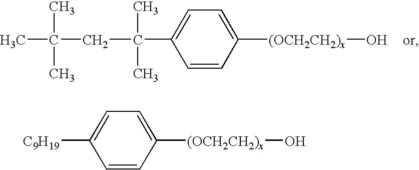

in which the C₉H₁₉ group in the latter formula is a mixture of branched chained isomers, and x indicates an average number of ethoxy units in the side chain. Particularly suitable non-ionic ethoxylated octyl and nonyl phenols include those having from about 7 to about 13 ethoxy groups. Such compounds are commercially available under the trade name Triton® X (Dow Chemical, Midland, Mich.), as well as under the tradename Igepal® (Rhodia, Princeton, N.J.). One exemplary and particularly preferred nonylphenol ethoxylate is Igepal® CO-630.

Still further examples of suitable nonionic surfactants which may be advantageously included in the inventive compositions are alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where EO represents ethylene oxide,
PO represents propylene oxide,
y equals at least 15,
(EO)_{x+z} equals 20 to 50% of the total weight of said compounds, and,
the total molecular weight is preferably in the range of about 2000 to 15,000.

Another group of nonionic surfactants for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein R is an alkyl group containing 1 to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

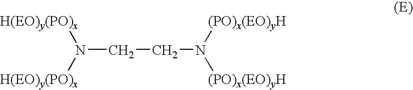

where (EO) represents ethoxy,

(PO) represents propoxy,

the amount of (PO)ₓ is such as to provide a molecular weight prior to ethoxylation of about 300 to 7500, and the amount of (EO)_{y} is such as to provide about 20% to 90% of the total weight of said compound.

A further class of useful nonionic surfactants amine oxides which can also be used as a non-ionic surfactant in the present invention. Exemplary amine oxides include:

A) Alkyl di (lower alkyl) amine oxides in which the alkyl group has about 10-20, and preferably 12-16 carbon atoms, and can be straight or branched chain, saturated or unsaturated. The lower alkyl groups include between 1 and 7 carbon atoms. Examples include lauryl dimethyl amine oxide, myristyl dimethyl amine oxide, and those in which the alkyl group is a mixture of different amine oxide, dimethyl cocoamine oxide, dimethyl(hydrogenated tallow)amine oxide, and myristyl/palmityl dimethyl amine oxide;

B) Alkyl di(hydroxy lower alkyl)amine oxides in which the alkyl group has about 10-20, and preferably 12-16 carbon atoms, and can be straight or branched chain, saturated or unsaturated. Examples are bis(2-hydroxyethyl)cocoamine oxide, bis(2-hydroxyethyl)tallowamine oxide; and bis(2-hydroxyethyl)stearylamine oxide;

C) Alkylamidopropyl di(lower alkyl)amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and

D) Alkylmorpholine oxides in which the alkyl group has about 10-20, and preferably 12-16 carbon atoms, and can be straight or branched chain, saturated or unsaturated.

Preferably the amine oxide constituent is an alkyl di (lower alkyl) amine oxide as denoted above and which may be represented by the following structure:

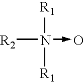

wherein each:

R₁ is a straight chained C₁-C₄ alkyl group, preferably both R₁ are methyl groups; and,

R₂ is a straight chained C₈-C₁₈ alkyl group, preferably is C₁₀-C₁₄ alkyl group, most preferably is a C₁₂ alkyl group. Each of the alkyl groups may be linear or branched, but most preferably are linear. Most preferably the amine oxide constituent is lauryl dimethyl amine oxide. Technical grade mixtures of two or more amine oxides may be used, wherein amine oxides of varying chains of the R₂ group are present. Preferably, the amine oxides used in the present invention include R₂ groups which comprise at least 50% wt., preferably at least 60% wt. of C₁₂ alkyl groups and at least 25% wt. of C₁₄ alkyl groups, with not more than 15% wt. of C₁₆, C₁₈ or higher alkyl groups as the R₂ group.

In the present invention, the preferred non-ionic surfactants and the amounts in which they are present are found in the Examples. Generally stated, when present the non-ionic surfactant present in the compositions ranges from about 0.1 to about 1 wt. %, preferably from about 0.15 to about 0.6 wt % of the composition and most preferably from about 0.2 to about 0.4 wt % of the composition. In certain preferred embodiments, at least one non-ionic surfactant is necessarily present in the compositions of the invention.

The surfactant system of the invention may include an anionic surfactant. Suitable anionic surfactants include, for example, alcohol sulfates (e.g. alkali metal or ammonium salts of alcohol sulfates) and sulfonates, alcohol phosphates and phosphonates, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof.

Further examples of anionic surfactants include water soluble salts or acids of the formula (ROSO₃)ₓM or (RSO₃)ₓM wherein R is preferably a C₆-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a mono-, di- or tri-valent cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like) and x is an integer, preferably 1 to 3, most preferably 1. Materials sold under the Hostapur and Biosoft trademarks are examples of such anionic surfactants.

Further examples of anionic surfactants include alkyl-diphenyl-ethersulphonates and alkyl-carboxylates. Other anionic surfactants can include salts (including, for example, sodium, potassium, ammonium, and substituted ammonium salts such as mono-, di-and triethanolamine salts) of soap, C₆-C₂₀ linear alkylbenzenesulfonates, C₆-C₂₂ primary or secondary alkanesulfonates, C₆-C₂₄ olefinsulfonates, sulfonated polycarboxylic acids prepared by sulfonation of the pyrolyzed product of alkaline earth metal citrates, C₆-C₂₄ alkylpolyglycolethersulfates (containing up to 10 moles of ethylene oxide); alkyl ester sulfates such as C₁₄₋₁₆ methyl ester sulfates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO⁻M⁺ wherein R is a C8-C₂₂ alkyl, k is an integer from 0 to 10, and M is a soluble salt-forming cation.

In the present invention, the preferred anionic surfactants and the amounts in which they are present are found in the Examples. Generally stated, when present, anionic surfactants are present in the compositions ranges from about 0.01 to about 5 wt. %, preferably from about 0.1 to about 2 wt % of the composition and most preferably from about 0.2 to about 1.5 wt % of the composition. In certain preferred embodiments, anionic surfactants are excluded from the inventive compositions.

The compositions are largely aqueous in nature, and comprise water. Water is added to order to provide to 100% by weight of the compositions of the invention. The water may be tap water, but is preferably distilled and is most preferably deionized water. If the water is tap water, it is preferably substantially free of any undesirable impurities such as organics or inorganics, especially mineral salts which are present in hard water which may thus undesirably interfere with the operation of the constituents present in the aqueous compositions according to the invention.

The compositions of the present invention can optionally contain one or more further constituents such as surfactants including cationic, amphoteric and zwitterionic surfactants, hydrotropes, one or more corrosion inhibitors, pH adjusting agents, pH buffering agents, perfumes, perfume carriers, antioxidants, antimicrobials, germicidals, fungicidals, acaricides, allergen neutralizes, and preservatives which, when present, should be present in minor amounts, preferably in total comprise less than about 7.5% by weight (on an active weight basis) of the compositions, preferably about 5% wt., and desirably less than about 3% wt. It is to be understood that in accordance with particularly preferred embodiments of the invention, the inventive compositions are essentially free of conventional chelating agents.

Exemplary useful corrosion inhibitors include alkanolamine compounds such as mono - and triethanolamine, ammonium hydroxide, sodium molybdate and sodium benzoate, nitrites such as sodium nitrite, morpholines, borates, carbonates and polycarbonates including bicarbonates, silicates, as well as other corrosion inhibitors well known to those of ordinary skill in the art. The corrosion inhibitor, when needed, is generally present in an amount of from about 0.01 to about 1.5% wt. of the composition, preferably from about 0.05 to about 1.3% wt., and most preferably from about 0.1 to about 1.2% wt. of the composition of which it forms a part.

Exemplary useful hydrotropes are sodium cumene sulfonate, sodium xylene sulfonate, di-sodium mono- and di-alkyl disulfonate, as well as n-octane sodium sulfonate, and the like. One or more hydrotropes may be included in the compositions in order to improve the stability of the compositions against separation into two or more liquid phases.

The compositions of the invention optionally but in certain embodiments desirably include an amount of a pH adjusting agent or pH buffer composition. Such compositions include many which are known to the art and which are conventionally used. By way of non-limiting example pH adjusting agents include phosphorus containing compounds, monovalent and polyvalent salts such as of silicates, carbonates, and borates, inorganic and organic acids, bases, tartrates and certain acetates. Exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. Desirably the compositions according to the invention include an effective amount of an organic acid and/or an inorganic salt form thereof which may be used to adjust and maintain the pH of the compositions of the invention to the desired pH range. Particularly useful is a hydroxide, especially ammonium hydroxide. This pH adjusting agent or pH buffer constituent is provided in an amount which is found to be effective in facilitating the removal of soap scum stains from hard surfaces, particularly lavatory and kitchen surfaces. Good results are attained when the pH adjusting agent or pH buffer constituent, especially a hydroxide constituent, is present in an amount of from 0% wt. to about 0.2% wt., especially from 0.1 % wt. to 0.2% wt. based on the total weight of the composition of which it forms a part. The compositions of the invention are preferably alkaline in nature, and are at a pH of greater than 7. More desirably the pH of the inventive compositions lie in the range of from about 8 to about 11, more preferably in the range of from about 8.2 to about 10.6, and most preferably are at a pH of between about 9.5 and about 10.5. In certain preferred embodiments, most desirably at least one pH adjusting agent or pH buffer composition is necessarily present in the inventive compositions. Particularly preferred pH adjusting agent or pH buffer compositions, as well as particularly preferred composition pH levels are disclosed amongst the Examples which include preferred embodiments of the invention.

As discussed above, in particularly preferred embodiments the inventive compositions are essentially free of chelating agents, more specifically those which are based on organic acid compounds, especially nitrogen containing organic compounds which include a plurality of carboxylic acid groups including ethylenediamine mono-, di- or tri-acetic acid, ethylenediaminetetraacetic acid. It is to be understood that by the term “essentially free”, the compositions comprise less than 0.05% wt. of the total composition, preferably less than 0.025% wt., and most preferably less than 0.01 % wt. of such chelating agents. Most preferably the inventive compositions are wholly free of chelating agents, especially nitrogen containing organic compounds which include a plurality of carboxylic acid groups.

The compositions of the invention are desirably provided as pressurized aerosol compositions and include propellants such as pressurized gases, including carbon dioxide, air, nitrogen, nitrous oxide, as well as others, for example, propane, butane, pentane, isobutane, isopentane, mixtures of hydrocarbon gases (such as, for example, A-46 and A-70 available from Phillips Petroleum, CAP 40 and CAP 48 available from Shell, BPAP 40 available from BP Chemicals), dimethyl ether, and mixtures thereof. The amount of propellant used is generally between 1 and 20% w/w of the entire composition. More preferably between 3 and 10% w/w of the entire composition. Advantageously, about 6% w/w propellant is used.

Alternately, the composition may be provided in a non-pressurized product format, such as in a non-pressurized container such as a non-pressurized vessel such as a bottle with an open end, or a nozzle, as well as in a trigger-spray container wherein the user manually operates a pump to dispense a quantity of the composition.

It is also contemplated that the composition may be provided in the form of a porous article such as a sponge such as a porous foamed synthetic polymer, e.g., a polyurethane sponge, a natural sponge, or a cellulose sponge such as a regenerated cellulose sponge. The composition may also be provided in the form of a “wipe” which is preimpregnated with the inventive composition. The wipe can be of a woven or non-woven nature. Fabric substrates can include nonwoven or woven pouches, sponges, in the form of abrasive or non-abrasive cleaning pads. Such fabrics are known commercially in this field, and are often referred to as wipes. Such substrates can be resin bonded, hydroentanged, thermally bonded, meltblown, needlepunched or any combination of the former.

The nonwoven fabrics may be a combination of wood pulp fibers and textile length synthetic fibers formed by well known dry-form or wet-lay processes. Synthetic fibers such as rayon, nylon, orlon and polyester as well as blends thereof can be employed. The wood pulp fibers should comprise about 30 to about 60 percent by weight of the nonwoven fabric, preferably about 55 to about 60 percent by weight, the remainder being synthetic fibers. The wood pulp fibers provide for absorbency, abrasion and soil retention whereas the synthetic fibers provide for substrate strength and resiliency.

The substrate of the wipe may also be a film forming material such as a water soluble polymer. Such self-supporting film substrates may be sandwiched between layers of fabric substrates and heat sealed to form a useful substrate. The free standing films can be extruded utilizing standard equipment to devolatilize the blend. Casting technology can be used to form and dry films, or a liquid blend can be saturated into a carrier and then dried in a variety of known methods.

The compositions of the present invention are absorbed onto the wipe to form a saturated wipe. The wipe can then be sealed individually in a pouch which can then be opened when needed or a multitude of wipes can be placed in a container for use on an as-needed basis. The container, when closed, is sufficiently sealed to prevent evaporation of any components from the compositions.

It is a surprising and advantageous feature of the inventive compositions, that very effective cleaning of soap scum, and sanitization of hard surfaces is achieved in such a foaming alkaline aerosol composition which contains a low level of surfactants and at the same time being essentially free of chelating agents based on organic acid compounds, especially nitrogen containing organic compounds which include a plurality of carboxylic acid groups.

The foaming alkaline composition of the present invention is designed so that it collapses, or breaks, within a short period of time, preferably less than ten minutes, more preferably less than five minutes, even more preferably less than one minute and most preferably less than thirty seconds. Alternatively the composition can give a bubbling action for a short period of time, preferably less than five minutes, more preferably less than one minute even more preferably less than thirty seconds. The quick breaking of the foam provides for an attractive visual appearance to the composition when applied to the locus of a stain on a hard surface needing a cleaning treatment.

The present invention also relates to a process for the removal of stains from hard surfaces in the need of a cleaning treatment which contemplates the step of: applying a cleaning effective amount of the composition according to the invention for a time period sufficient to aid in the loosening of a surface stain, preferably a soap scum stain, or a greasy soil stain, and therafter wiping or rinsing the treated surface.

The foaming alkaline hard surface cleaning composition according to the invention is desirably provided as a ready to use product in a pressurized container, especially a convention aerosol container or package which permits for the inventive composition to be directly applied to a hard surface. By way of example, hard surfaces suitable for coating with the polymer include surfaces composed of refractory materials such as: glazed and unglazed tile, brick, porcelain, ceramics as well as stone including marble, granite, and other stones surfaces; glass; metals; plastics e.g. polyester, vinyl; fiberglass, Formica®, Corian® and other hard surfaces known to the industry. Hard surfaces which are to be particularly denoted are lavatory fixtures such as shower stalls, bathtubs and bathing appliances (racks, curtains, shower doors, shower bars) toilets, bidets, wall and flooring surfaces especially those which include refractory materials and the like. Further hard surfaces which are to be denoted are those associated with kitchen environments and other environments associated with food preparation, including cabinets and countertop surfaces as well as walls and floor surfaces especially those which include refractory materials, plastics, Formica®, Corian® and stone. It is to be particularly noted that due to the alkaline characteristics of the inventive composition, the compositions taught herein are particularly useful in the cleaning and sanitization of so-called European porcelain surfaces which are sensitive to acids as well as to many conventional chelating agents.

The following examples below illustrate exemplary and preferred formulations of the concentrate composition according to the instant invention. It is to be understood that these examples are presented by means of illustration only and that further useful formulations fall within the scope of this invention and the claims may be readily produced by one skilled in the art and not deviate from the scope and spirit of the invention.

Throughout this specification and in the accompanying claims, weight percents of any constituent are to be understood as the weight percent of the active portion of the referenced constituent, unless otherwise indicated.

### EXAMPLES

The following examples illustrate the formulation and performance of various compositions of the invention.

Exemplary formulations illustrating certain preferred embodiments of the inventive compositions and described in more detail in Table 1 below were formulated generally in accordance with the following protocol. The weight percentages indicated the “as supplied” weights of the named constituent.

Into a suitably sized vessel, a measured amount of water was provided after which the constituents were added in no specific or uniform sequence, which indicated that the order of addition of the constituents was not critical. All of the constituents were supplied at room temperature, and any remaining amount of water was added thereafter. The total amount of water is indicated as “quantum sufficient” (“q.s.”) which indicated that sufficient water was present in order to provide a total of 100% wt. of each composition. Certain of the nonionic surfactants, if gels at room temperature, were first preheated to render them pourable liquids prior to addition and mixing. Mixing of the constituents was achieved by the use of a mechanical stirrer with a small diameter propeller at the end of its rotating shaft. Mixing, which generally lasted from 5 minutes to 120 minutes was maintained until the particular exemplary formulation appeared to be homogeneous. The exemplary compositions were readily pourable, and retained well mixed characteristics (i.e., stable mixtures) upon standing for extend periods. The compositions of the example formulations are listed on Table 1. Subsequently a suitable amount of each composition was provided to a suitable container useful to dispense aerosols, and then a propellant was added. For the examples below, a charge of the example formulation (equal to 94% of a respective “Example” composition) is placed in a suitable canister and charged with 6% propellant.

TABLE 1

| | E1 | E2 | E3 |
|---|---|---|---|
| Dowanol DPnB | 4.5 | — | 4.5 |
| Dowanol DPM | 12.5 | — | 12.5 |
| Dowanol PnP | — | 17 | — |
| Genapol 26-L-60 | — | 0.2 | — |
| Genapol 26-L-80 | 0.2 | — | 0.2 |
| Sodium Benzoate | 0.3 | 0.3 | — |
| Monacor BE | — | — | 0.5 |
| Ammonium | 0.05 | 0.05 | 0.05 |
| Hydroxide | | | |
| DI Water | q.s. | q.s. | q.s. |
| pH | 9.8-10.4 | 10.0-10.3 | 9.8 |

| | E4 | E5 | E6 | E7 | E8 | E9 | E10 |
|---|---|---|---|---|---|---|---|
| Dowanol DPnB | — | — | 4.5 | 4.5 | — | — | 4.5 |
| Dowanol DPM | — | — | 12.5 | 12.5 | — | — | 16.5 |
| Dowanol PnP | — | — | — | — | 17 | 17 | — |
| Dowanol EB | 15 | 15 | — | — | — | — | — |
| IPA | 5 | 5 | — | — | — | — | — |
| Genapol 26-L-60 | — | — | — | — | 0.2 | 0.2 | — |
| Genapol 26-L-80 | — | — | 0.2 | 0.2 | — | — | 0.2 |
| Triton X-100 | 0.05 | 0.05 | — | — | — | — | — |
| Sodium Benzoate | — | — | — | 0.3 | 0.3 | — | — |
| Monacor BE | — | 0.5 | — | 0.8 | 0.8 | — | — |
| Sodium Nitrite | 0.1 | — | 0.2 | — | — | 0.2 | 0.2 |
| Ammonium | 0.1 | 0.1 | 0.05 | 0.05 | 0.05 | 0.05 | 0.05 |
| Hydroxide | | | | | | | |
| DI Water | q.s. | q.s. | q.s. | q.s. | q.s. | q.s. | q.s. |
| pH | 10.06 | 9.75 | 9.87 | 10.11 | 9.87 | 10.27 | 10.09 |

| | E11 | E12 | E13 | E14 | E15 | E16 | E17 |
|---|---|---|---|---|---|---|---|
| Dowanol DPnB | 4.5 | 3.5 | — | — | — | 17 | — |
| Dowanol DPM | 16.5 | 17.5 | 8.5 | — | — | — | — |
| Dowanol PnP | — | — | 8.5 | — | — | — | — |
| Dowanol EB | — | — | — | 17 | 17 | — | — |
| Dowanol PM | — | — | — | — | — | — | 17 |
| Genapol 26-L-60 | — | — | 0.2 | 0.2 | 0.2 | 0.2 | 0.2 |
| Genapol 26-L-80 | 0.2 | 0.2 | — | — | — | — | — |
| Sodium Benzoate | 0.3 | 0.3 | 0.3 | 0.3 | 0.3 | 0.3 | 0.3 |
| Monacor BE | 0.8 | 0.8 | 0.8 | — | — | — | — |
| Sodium | — | — | — | 0.1 | 0.1 | 0.34 | 0.1 |
| Bicarbonate | | | | | | | |
| Fragrance | — | — | — | 0.2 | 0.2 | 0.2 | 0.2 |
| Ammonium | 0.05 | 0.05 | 0.05 | — | 0.02-0.05 | 0.02-0.05 | 0.02-0.05 |
| Hydroxide | | | | | | | |
| DI Water | q.s. | q.s. | q.s. | q.s. | q.s. | q.s. | q.s. |
| pH | 9.93 | 9.83 | 9.88 | 8.98 | 8.9 | 8.94 | 9.5 |

| | E18 | E19 | E20 | E21 | E22 | E23 | E24 |
|---|---|---|---|---|---|---|---|
| Dowanol DPnB | — | — | — | — | — | 4.5 | 4.5 |
| Dowanol EB | — | 17 | — | — | 8.5 | — | — |
| Dowanol DB | 17 | — | — | — | — | — | — |
| Dowanol DPM | — | — | — | — | — | 12.5 | 12.5 |
| m-Pyrol | — | — | 17 | 15.5 | 8.5 | — | — |
| Hexyl Cellosolve | — | — | — | 1.5 | — | — | — |
| Genapol 26-L-3 | — | 0.2 | — | — | — | — | — |
| Genapol 26-L-60 | 0.2 | — | 0.2 | 0.2 | 0.2 | — | — |
| Neodol 91-2.5 | — | — | — | — | — | 0.2 | — |
| Tergitol 15-S-9 | — | — | — | — | — | — | 0.2 |
| Sodium Benzoate | 0.3 | 0.3 | 0.3 | 0.3 | 0.3 | 0.3 | 0.3 |
| Sodium | 0.17 | 0.17 | — | — | — | — | — |
| Bicarbonate | | | | | | | |
| Fragrance | 0.2 | 0.2 | — | — | — | — | — |
| Ammonium | 0.02-0.05 | 0.02-0.05 | 0.05 | 0.05 | 0.05 | 0.05 | 0.05 |
| Hydroxide | | | | | | | |
| DI Water | q.s. | q.s. | q.s. | q.s. | q.s. | q.s. | q.s. |
| pH | 8.94 | 8.85 | 9.88 | 9.9 | 10.05 | — | — |

| | E25 | E26 | E27 | E28 | E29 | E30 | E31 |
|---|---|---|---|---|---|---|---|
| Dowanol DPnB | 4.5 | 4.5 | 4.5 | 4.5 | 4.5 | 4.5 | 4.5 |
| Dowanol DPM | 12.5 | 12.5 | 12.5 | 12.5 | 12.5 | 12.5 | 12.5 |
| Eltesol SC 40 | 5 | 2.2 | 5 | 5 | 2.5 | 1.25 | — |
| Dowfax 3B2 | — | — | — | — | — | — | 1.13 |
| Genapol 26-L-80 | 0.2 | 0.2 | 0.2 | 0.2 | 0.2 | 0.2 | 0.2 |
| Sodium Benzoate | 0.3 | 0.3 | 0.6 | — | 0.6 | 0.6 | 0.3 |
| Monacor BE | — | — | — | 0.5 | 0.82 | 0.82 | — |
| Sodium | — | — | — | — | — | — | 0.17 |
| Bicarbonate | | | | | | | |
| Fragrance | — | 0.1 | — | — | — | — | 0.1 |
| Ammonium | 0.05 | 0.05 | 0.05 | 0.05 | 0.15 | 0.15 | — |
| Hydroxide | | | | | | | |
| DI Water | q.s. | q.s. | q.s. | q.s. | q.s. | q.s. | q.s. |

Each of the foregoing example compositions exhibited a pH of at least 8.5, or higher as indicated with respect to certain of the examples which had their pH tested.

The constituents used to form the foregoing example compositions are listed on the following Table 2.

TABLE 2

| | |
|---|---|
| Dowanol DPnB | dipropylene glycol n-propyl ether supplied as |
| | Dowanol ® DPnP (Dow Chem. Co., Midland MI) |
| Dowanol DPM | dipropylene glycol methyl ether supplied as |
| | Dowanol ® DPM (Dow Chem. Co., Midland MI) |
| Dowanol PnP | propylene glycol n-propyl ether supplied as |
| | Dowanol ® DPnP (Dow Chem. Co., Midland MI) |
| Dowanol EB | ethylene glycol n-butyl ether supplied as Dowanol ® |
| | EB (Dow Chem. Co., Midland MI) |
| Dowanol DB | diethylene glycol monobutyl ether, supplied as |
| | Dowanol ® DB (Dow Chem. Co., Midland MI) |
| IPA | isopropanol, technical grade |
| m-Pyrol | N-methylpyrrolidone |
| Hexyl Cellosolve | ethylene glycol hexyl ether |
| Genapol 26-L-3 | linear C₁₂-C₁₆ alcohol ethoxylated with an average of |
| | 1 ethoxy group, 100% wt. actives (Clariant Corp., |
| | Muttenz, Switzerland) |
| Genapol 26-L-60 | linear C₁₂-C₁₆ primary alcohol ethoxylate, with an |
| | average of 7 ethoxy groups, 100% wt. actives |
| Genapol 26-L-80 | linear C₁₂-C₁₆ primary alcohol ethoxylate, with an |
| | average of 9 ethoxy groups, 100% wt. actives |
| | (Clariant Corp., Muttenz, Switzerland) |
| Triton X-100 | octylphenoxy polyethoxyethanol nonionic surfactant |
| Neodol 91-2.5 | linear C₉-C₁₁ primary alcohol ethoxylate, with an |
| | average of 2.5 ethoxy groups, 100% wt. actives |
| Tergitol 15-S-9 | C₁₁-C₁₅ secondary alkanol condensed with 9 mols of |
| | ethylene oxide, 100% wt. actives (Union Carbide Div. |
| | of Dow Chemical) |
| Eltesol SC 40 | sodium cumene sulfonate |
| Dowfax 3B2 | diphenyl oxide disulfonate, 45% wt. active |
| Monacor BE | monoethanolamine borate/monoisopropanolamine |
| | borate |
| Sodium Benzoate | sodium benzoate |
| Sodium Nitrite | sodium nitrite |
| Sodium | sodium bicarbonate |
| Bicarbonate | |
| Fragrance | proprietary composition, various formulations |
| Ammonium | ammonium hydroxide |
| Hydroxide | |
| DI Water | deionized water |

Compositions according to the invention were evaluated for their cleaning performance in accordance with one or more of the following test protocols. The cleaning performance was evaluated against a number of commercially available products in order to provide a basis for comparison.

### Soap Scum Cleaning Evaluation:

The efficacy of compositions according to present invention (example “E2”) as well as comparative examples based on commercial products in removing soap scum from a hard surface was evaluated in accordance with CSMA Methods DCC-16 (May 1995) titled “Guidelines for Evaluating the Efficacy of Bathroom Cleaners—Part 2: Scrubber Test for Measuring the Removal of Lime Soap”. This test is described generally as follows:

First, a “parent” soil is made, based on the following formulation:

| “Parent” soil | % w/w |
|---|---|
| bar soap | 3.90 |
| shampoo | 0.35 |
| clay | 0.06 |
| artificial sebum | 0.15 |
| hard water | 95.54 |

The parent soil was produced according to the following steps: First, the bar soap was shaved into a suitable beaker. Afterward the remaining constituents were added in the order given above and stirred with three-blade propeller mixer. Next, the contents of the beaker was heated to 45-50° C. and mixed until a smooth, lump-free suspension was achieved. This usually required about two hours with moderate agitation. Subsequently, the contents of the beaker were filtered through a Buchner funnel fitted with Whatman #1 filter paper or equivalent. The filtrate was then resuspended in clean, deionized water, using the same amount of water used to make the soil, and this was filtered again. The (re-filtered) filtrate was uniformly dried overnight at 45° C. to form a filter cake. Thereafter, the filter cake was pulverized and was suitable for immediate use, or may be stored in a sealed container for up to six months.

The test substrates (glass mirror plates, 4 inches by 12 inches in surface area) were prepared in the following manner: each test substrate was thoroughly washed (using a commercially available hand dishwashing detergent such as, Dove®) and scrubbed using a non-metallic scouring pad (such as a Chore Boy® Long Last scrubbing sponge). The washed test substrates were then permitted to dry in an oven at 40.5° C. overnight, then withdrawn and allowed to cool to room temperature (approx. 20° C.) before being provided with the standardized “hard water” test soil.

In preparation for supplying the test substrates with an amount of the test soil, a test soil was prepared based on the following formulation:

| Test soil: | % w/w |
|---|---|
| “parent” soil | 4.50 |
| hard water | 9.0 |
| hydrochloric acid (0.1N) | 0.77 |
| acetone | 85.73 |

The test soil was produced according to the following steps: The constituents indicated were introduced into a clean beaker, with the acetone being added prior to the water, and the ‘parent’ soil being added last. The contents of the beaker were mixed using a standard three blade laboratory mixer until the contents formed a uniform mixture, and the color changed from white to gray. This typically required 20-40 minutes, during which time the beaker was covered as much as possible to avoid excessive solvent loss. Next, a suitable quantity of the contents of the test soil from the beaker was provided to an artist's airbrush while the beaker was swirled to ensure soil uniformity. (If testing required more than one day, a fresh amount of test soil was prepared daily and used for that day's testing.)

Soil was applied to a number of clean, dry test substrates placed into rows and columns in preparation for depositing of the test soil. The airbrush was operated at 40 psi, and the test soil was sprayed to provide a visually uniform amount of soil onto the test substrates. (Uniform soil suspension during application was maintained by continuous brush motion and/or swirling of test soil in the airbrush.) In this manner, approximately 0.10 g-0.15 g test soil were applied per test substrate. The test substrates were then allowed to air dry.

To evaluate cleaning, a treated test substrate was placed in a SHEEN wet abrasion scrub tester (Reference: 903PG) and secured. Dry 10 cm by 7.6 cm sponges were first moistened with 100 g of tap water, and the excess wrung out from the sponges. Thereafter the sponges were overwrapped with a nonporous polymer film in order to enclose the sponges. For each tested composition (example E2, as well as for each comparative example), a 2 gram amount of a composition was loaded onto a uniformly sized sheet of dry paper towel, which was then wrapped to enrobe a polymer film wrapped sponge, and then inserted into the holder of the SHEEN tester. The SHEEN tested was then actuated and controlled to provide 6 cleaning cycles (12 linear strokes over the surface) over the test soil on a test substrate, and thereafter the test substrate was removed, rinsed with approximately equal amounts of tap water, and dried with compressed air from an airbrush compressor. This test was repeated several times for each composition in order to provide 4 replicates for each tested composition.

Subsequently the treated test substrates (mirrors) were laid out in a side-by-side manner on a horizontal surface which was well illuminated. The treated test substrates (mirrors) were then visually assessed by twenty (human) panelists who were asked to rate the cleaning efficacy achieved by each composition, and asked to rank the cleaning efficacy on a scale of “0” where no visual cleaning was observed to “100”, wherein complete removal of the stain was observed. For comparative purposes and to provide a common baseline for comparison, each panelist was provided with a new test substrate which as used to represent a score of “100% cleaning”, and an uncleaned, soiled test substrate which was used to represent a score of “0% cleaning”. The scores were summed and averaged for each of the tested compositions; the results are reported on the following Table A:

TABLE A
Soap Scum Cleaning

| | % cleaning |
|---|---|
| Example “E2” | 75.80 |
| AJAX “Crystal Clean”¹ | 4.71 |
| FLASH “Multi-Surface & Glass”² | 8.40 |
| MR. CLEAN “Multi-Surface Antibacterial”³ | 5.01 |
| MR. SHEEN “Metal Cleans and Shine”⁴ | 1.37 |
| VIGOR “Multi-Surfaces + Vitress”⁵ | 9.92 |
| WEIMAN Stainless Steel Cleaner & Polish⁶ | 11.67 |
| WINDEX “Multi-Task”⁷ | 7.71 |

¹AJAX “Crystal Clean” (ex. Colgate-Palmolive)
²FLASH “Multi-Surface & Glass” (ex. Procter & Gamble)
³MR. CLEAN “Multi-Surface Antibacterial” (ex. Procter & Gamble)
⁴MR. SHEEN “Metal Cleans and Shine” (ex. Reckitt Benckiser plc (UK))
⁵VIGOR “Multi-Surfaces + Vitress” (ex. Eauecarlate S.A.S. (FR))
⁶WEIMAN Stainless Steel Cleaner & Polish (ex. The Herbert Stanley Co.)
⁷WINDEX “Multi-Task” (ex. SC Johnson & Son Co.)

As is readily evident from the results reported on Table A, the composition of the invention was far superior than those of the commercially available compositions to which the formulation of Example E2 was compared.

### Evaluation of Organic Soil Cleaning

The efficacy of compositions according to present invention (example “E2”) as well as comparative examples based on commercial products were performed in accordance with the testing protocol outlined according to ASTM D4488 A2 Test Method, which evaluated the efficacy of the cleaning compositions in removing a standardized greasy organic soil on masonite wallboard samples painted with white wall paint. The soil applied was a standardized greasy soil containing:

| Test Greasy Soil | % w/w |
|---|---|
| vegetable oil | 33 |
| vegetable shortening | 33 |
| lard | 33 |
| carbon black | 1 |

which were blended together to homogeneity under gentle heating to form a uniform mixture which was later allowed to cool to room temperature. The sponge (water dampened) of a Gardner Abrasion Tester apparatus was squirted with a 15 gram sample of a tested cleaning composition, and the apparatus was cycled 6 times (12 linear strokes over the surface). The test was replicated 4 times for each tested composition. The tiles were dried, and then the cleaning efficacy was evaluated.

The cleaning efficacy of the tested compositions was evaluated utilizing a high resolution digital imaging system which evaluated the light reflectance characteristics of the each tested sample wallboard sample. This system utilized a photographic copy stand mounted within a light box housing which provided diffuse, reflected light supplied by two 15 watt, 18 inch type T8 fluorescent bulbs rated to have a color output of 4100K which approximated “natural sunlight” as noted by the manufacturer. The two fluorescent bulbs were positioned parallel to one another and placed parallel and beyond two opposite sides of the test substrate (test tile) and in a common horizontal plane parallel to the upper surface of the test substrate being evaluated, and between the upper surface of the tile and the front element of the lens of a CCD camera. The CCD camera was a “QImaging Retiga series” CCD camera, with a Schneider-Kreuznach Cinegon Compact Series lens, f1.9/10 mm, 1 inch format (Schneider-Kreuznach model #21-1001978) which CCD camera was mounted on the copy stand with the lens directed downwardly towards the board of the copy stand on which a test substrate was placed directly beneath the lens. The light box housing enclosed the photographic copy stand, the two 18 inch fluorescent bulbs and a closeable door permitted for the insertion, placement and withdrawal of a test tile which door was closed during exposure of the CCD camera to a test tile. In such a manner, extraneous light and variability of the light source during the evaluation of a series of tested substrates was minimized, also minimizing exposure and reading errors by the CCD camera.

The CCD camera was attached to a desktop computer via a Firewire IEEE 1394 interface and exposure data from the CCD camera was read by a computer program, “Media Cybernetics Image Pro Plus v. 6.0”, which was used to evaluate the exposures obtained by the CCD camera, which were subsequently analyzed in accordance with the following. The percentage of the test soil removal from each test substrate (tile) was determined utilizing the following equation:

$$\% Removal = \frac{R C - R S}{R O - R S} \times 100$$

where

RC=Reflectance of tile after cleaning with test product

RO=Reflectance of original soiled tile

RS =Reflectance of soiled tile

The results of this evaluation was averaged for each of the tested compositions, and the results of the evaluation are reported on the following Table B.

TABLE B
Organic Soil Cleaning

| | % cleaning |
|---|---|
| Example “E2” | 73.63 |
| AJAX “Crystal Clean” | 35.26 |
| FLASH “Multi-Surface & Glass” | 50.84 |
| MR. CLEAN “Multi-Surface Antibacterial” | 60.64 |
| VIGOR “Multi-Surfaces + Vitress” | 40.74 |
| WINDEX “Multi-Task” | 31.51 |

As is readily evident from the results reported on Table B, the composition of the invention was superior than those of the commercially available compositions to which the formulation of Example E2 was compared.

### Evaluation of Baked Greasy Soil Cleaning

The efficacy of compositions according to present invention (example “E2”) as well as comparative examples based on commercial products was evaluated in accordance with the following test protocol which was used to evaluate cleaning efficacy of baked on, tough greasy soils on a hard surfaces.

A “baked greasy test soil” was prepared from “Part I” and “Part II” soils which were prepared as follows.

The “Part I” soil was prepared by mixing together the ingredients indicated on the following table

| Part I soil | % w/w |
|---|---|
| Peanut oil | 26.2 |
| Corn oil | 14.5 |
| Cherry pie filling | 14.5 |
| Ground beef | 14.5 |
| Ground pork | 14.5 |
| Accent ® (monosodium glutamate flavor aid) | 0.60 |
| Table salt | 0.60 |
| Deionized water | 14.6 |

and thereafter baking the mixture in a glass baking dish at 400° F. (205° C.) for 2 hours. The Part I soil was allowed to cool to 100° C. or less. After being prepared, the Part I may be divided into aliquots for later use and refrigerated in glass jars. If a refrigerated aliquot is later used, it is first heated in a hot water bath to 100° C. and stirred or shaken prior to mixture with an amount of the Part II soil.

The Part II soil was “Kitchen Bouquet®”, a bottled food product believed used to flavor and color gravy; it is believed to be burnt sugar caramel, which is used as supplied from the manufacturer.

The baked greasy test soil used in the evaluation is mixed immediately prior to soiling test tiles by combining 83.3% wt. of the Part I soil at a temperature of 100° C. with 16.7% wt. of the Part II by blending in a laboratory beaker for a minimum of 5 minutes using a hand held homogenizer.

As test substrates, white porcelain enameled steel tiles (4 inches by 4 inches) in size were used. The enameled tiles are all first cleaned with mild hand dishwashing detergent, wiped with ethanol and placed in vertical racks and allowed to dry and cool to room temperature, approx. 68° F. (20° C.).

The baked greasy soil was heated to 100° C. in a water bath, and kept homogenized during application to test tiles to avoid settling of the baked greasy soil. Prior to application of the baked greasy soil, each tile was weighed. The baked greasy soil was thereafter applied to the dry test tiles by depositing 0.75 grams (±0.10 grams) on the porcelain surface of each test tile using a small kitchen basting brush which was used to uniformly distribute said soil. After application, the test tile was reweighed to assure that at least 0.75 grams were deposited on the tile. If needed, a few additional drops of the baked greasy soil was applied to the tile, and applied by brushing and the tile reweighed to ensure that at least 0.75 grams of the baked greasy soil were deposited on the tile. This procedure was repeated until at least 0.75 grams of the baked greasy soil were deposited on the tile. Thereafter, the tile was placed on metal baking tray and covered prior to subsequent tile baking. When sufficient test tiles were coated with the requisite amount of the baked greasy soil, the covered tiles were baked in convention oven at 300° F. for 90 minutes to further solidify the baked greasy soil. After the 90 minute time period, the baking trays were removed from the oven, the covers removed and the tiles were allowed to cool at least 12 hours, (typically overnight,) prior to being used in the cleaning evaluation of a sample composition.

Standard sized cellulose test sponges, approximately 10 cm by 7.6 cm sponges were subjected to three rinse and spin dry cycles in a domestic laundry washing machine in order to ensure that all soils, detergents or other contaminants were flushed from the sponges. After the third spin cycle, the sponge were removed from said machine and placed in a tightly sealed plastic container to maintain cleanliness as well as their relative dampness prior to their use in a cleaning evaluation.

To evaluate cleaning, a soiled test tile prepared as indicated above was placed in a SHEEN wet abrasion scrub tester (Reference: 903PG) and secured. Prior to use, the dampened sponges were overwrapped with a nonporous polymer film in order to enclose the sponges and provide a liquid barrier between the sponge and a composition to be tested. For each tested composition (example E2, as well as for each comparative example), a 50 ml amount of a composition was loaded onto a uniformly sized sheet of dry wipe, e.g., a dry paper towel, which was then wrapped to enrobe a polymer film wrapped sponge, and then inserted into the holder of the SHEEN tester. A 200 gram weight was added to each of the sponge holders in order to ensure compression of the sponge and good surface scrubbing of the soiled test tile with the wetted paper towel The SHEEN tested was then actuated and controlled to provide 3 cleaning cycles (6 linear strokes over the surface) over the test soil on a test substrate, and thereafter the test substrate was removed, rinsed with approximately equal amounts of tap water, and dried with compressed air from an airbrush compressor. This test was repeated several times for each composition in order to provide 4 replicates for each tested composition.

Subsequently the treated test tiles were laid out in a side-by-side manner on a horizontal surface which was well illuminated. The treated test tiles were then visually assessed by twenty (human) panelists who were asked to rate the cleaning efficacy achieved by each composition, and asked to rank the cleaning efficacy on a scale of “0” where no visual cleaning was observed to “100”, wherein complete removal of the stain was observed. For comparative purposes and to provide a common baseline for comparison, each panelist was provided with a new stainless steel tile which as used to represent a score of “100% cleaning”, and an uncleaned, soiled test tile which was used to represent a score of “0% cleaning”. The scores were summed and averaged for each of the tested compositions; the results are reported on the following Table C:

TABLE C
Baked Greasy Soil Cleaning

| | % cleaning |
|---|---|
| Example “E2” | 22.71 |
| AJAX “Crystal Clean” | 3.97 |
| FLASH “Multi-Surface & Glass” | 53.86 |
| MR. CLEAN “Multi-Surface Antibacterial” | 38.19 |
| MR. SHEEN “Metal Cleans and Shine” | 6.59 |
| VIGOR “Multi-Surfaces + Vitress” | 6.05 |
| WEIMAN Stainless Steel Cleaner & Polish | 6.65 |
| WINDEX “Multi-Task” | 0.98 |

As is readily evident from the results reported on Table C, the composition of the invention was superior than several of the commercially available compositions to which the formulation of Example E2 was compared.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof Therefore, it is intended that the invention not be limited to the particular embodiments disclosed in the above detailed description, but that the invention will include all embodiments falling within the scope of the appended claims.

1. An alkaline ready to use cleaning composition effective for the removal of soap scum stains on hard surfaces and which is essentially free of a chelating agent based on a nitrogen containing organic acid compound, which comprises:
at least 1 5% wt. of one or more organic solvents;
a nonionic surfactant;
and, water.

2. An alkaline ready to use cleaning composition effective for the removal of soap scum stains on hard surfaces and which is essentially free of a chelating agent based on a nitrogen containing organic acid compound, which comprises:
at least 1 5% wt. of one or more organic solvents;
a nonionic surfactant;
a propellant;
and, water.

3. A process for the cleaning of a hard surface which comprises the step of:
applying a cleaning effective amount of the composition of claim 1 to said hard surface.

4. A process for the cleaning of a hard surface which comprises the step of:
applying a cleaning effective amount of the composition of claim 2 to said hard surface.

5. An alkaline ready to use cleaning composition according to claim 1 which comprises: 15%-40% wt. of one or more glycol ethers.

6. An alkaline ready to use cleaning composition according to claim 1 having a pH of at least 8.5.

7. A foaming, alkaline ready to use cleaning composition according to claim 1.

8. An alkaline ready to use cleaning composition according to claim 1 which comprises a hydrotrope.

9. An alkaline ready to use cleaning composition according to claim 2 which comprises:
15%-40% wt. of one or more glycol ethers.

10. An alkaline ready to use cleaning composition according to claim 2 which comprises a hydrotrope.

11. An alkaline ready to use cleaning composition according to claim 2 having a pH of at least 8.5.

12. A foaming, alkaline ready to use cleaning composition according to claim 2.
